(19) United States
(12) Patent Application Publication
(10) Pub. No.: US 2014/0274047 A1
(43) Pub. Date: Sep. 18, 2014

(54) ROUTING PAGING MESSAGES FOR MULTIPLE SUBSCRIPTION IDENTITIES OF A SINGLE COMMUNICATION DEVICE VIA A SINGLE PAGING CHANNEL

(71) Applicant: QUALCOMM INCORPORATED, San Diego, CA (US)

(72) Inventors: Mungal DHANDA, Slough (GB); Divaydeep SIKRI, Woking (GB)

(73) Assignee: QUALCOMM INCORPORATED, San Diego, CA (US)

(21) Appl. No.: 13/831,709

(22) Filed: Mar. 15, 2013

(51) Int. Cl. H04W 40/02

(52) U.S. Cl. CPC H04W 40/02
USPC 455/435.1; 455/458

(57) ABSTRACT

A method is provided for conserving power on a wireless communication device having multi-subscription capabilities. Instead of scanning different paging channels for each of a plurality of subscriptions, power may be conserved by using a single paging channel from a serving access network for all paging messages from the plurality of subscriptions. The wireless communication device may provide a serving access network information for the plurality of subscriptions, where each of the plurality of subscriptions is associated with a different paging channel. The serving access network may select or obtain a single paging channel for all paging messages from different core networks associated with the plurality of subscriptions. The wireless communication device may be informed of the selected paging channel by the access network so it monitors for paging messages for all subscriptions on that selected paging channel only.

### FIELD

The present disclosure pertains to paging channels for wireless communication devices having multiple wireless subscriptions.

### BACKGROUND

Some mobile communication devices are now equipped with multiple wireless subscriber identity modules (SIMs) and/or multiple wireless radio access technologies, allowing such devices to obtain wireless communication services from multiple providers over the same or different radio access networks. Such devices are currently required to monitor the paging channel(s) for each service provider with which they subscribe and which is active in a given cell or region. Each service provider may have an associated group of paging channels (within a cell or region) that a subscriber mobile communication device should monitor (e.g., for incoming calls or establish service). Consequently, for a mobile communication device having multiple wireless service subscriptions (e.g., subscriber identities and access network parameters), this means monitoring many different paging channels (e.g., different paging channel groups for each service provider). Such paging channel monitoring increases power consumption of the mobile communication device and, in some cases, may result in missed paging messages. Furthermore, when the mobile communication device uses one of its subscriptions to establish a communication session (e.g., enters a connected mode), it may not be able to monitor the paging channels for the other subscriptions (e.g., idle mode subscriptions).

Therefore, a solution is needed that allows a multi-subscription mobile communication device to receive paging messages from different wireless service subscriptions while conserving power.

### SUMMARY

According to one aspect, a method operational on a wireless communication device is provided for using a single paging channel for paging messages from a plurality of subscriptions. The wireless communication device may register with at least one of a serving access network or a first core network while providing information for a plurality of subscriptions, including the first subscription, of the wireless communication device, where each of the plurality of subscriptions is associated with a different paging channel.

The plurality of subscriptions may facilitate wireless communication services for the wireless communication device over two or more different core networks. In one example, each of the plurality of subscriptions is associated with a different core network. For instance, each subscription in the plurality of subscriptions is to be registered separately with a core network that is different from other core networks for other subscriptions in the plurality of subscriptions.

The wireless communication device may provide the information for the plurality of subscriptions to the serving access network in order to reduce the number paging channels it monitors for paging messages. The different paging channels for the plurality of subscriptions to the first paging channel may be unknown to the first core network.

In response, the wireless device may receive an indication that a first paging channel associated with one of the plurality of subscriptions has been obtained or selected for all paging messages for the plurality of subscriptions. The first paging channel may have been previously associated with the first subscription. In another example, the first paging channel may be associated with a subscription different from the first subscription. In one example, the first paging channel may correspond to a subscription from the plurality of subscriptions that is in a connected mode. The indication may identify an existing subscription, from the plurality of subscriptions, associated with the first paging channel.

The wireless communication device may then monitor the first paging channel for paging messages for the plurality of subscriptions. Paging messages may be received from at least two of the plurality of subscriptions over the first paging channel.

In one example, the wireless communication device may ascertain a preferred paging channel, from among a plurality of paging channels associated with the plurality of subscriptions. It then provides an indication of the preferred paging channel to the serving access network.

According to one example, the preferred paging channel is ascertained from at least one of: (a) a paging channel having the lowest noise-to-energy ratio from among the plurality of paging channels; (b) a paging channel having the highest signal energy from among the plurality of paging channels; and/or (c) a paging channel associated with a subscription that is in a connected mode when registration with the serving access network is initiated.

According to another aspect, a method operational on an access network device (e.g., paging device) is provided for using a single paging channel for paging messages from a plurality of subscriptions. The access network device may receive a plurality of subscriptions from a wireless communication device, where each of the plurality of subscriptions is associated with a different paging channel. Each of the plurality of subscriptions may be associated with a different core network. The plurality of subscriptions may facilitate wireless communication services for the wireless communication device over two or more different core networks. In one example, each subscription in the plurality of subscriptions is to be registered separately with a core network that is different from other core networks for other subscriptions in the plurality of subscriptions.

The access network device may then obtain or select a first paging channel associated with a first subscription from the plurality of subscriptions. The first paging channel may have been previously associated with the first subscription. The first paging channel is associated with a subscription different from the first subscription.

The access network device may send a message to the wireless communication device indicating that the first paging channel has been selected for sending all paging messages for the plurality of subscriptions. The access network device may then route paging messages for the wireless communication device from the plurality of subscriptions via the first paging channel. For instance, the access network device may send paging messages for the plurality of subscriptions to the wireless communication device via the first paging channel. Routing of the different paging channels for the plurality of subscriptions to the first paging channel is unknown to a plurality of core networks associated with the plurality of subscriptions.

In one example, the access network device may inform a second access network that paging messages for at least one of the plurality subscriptions should be routed to the first access network.

According to one example, the wireless communication device may indicate a preference for using the first paging channel associated with the first subscription to receive paging messages for the plurality of subscriptions.

In one example, the first paging channel may be selected after ascertaining that: (a) the first paging channel is in a connected mode with a first core network; (b) the first paging channel has the lowest noise-to-energy ratio from among a plurality of paging channels associated with the plurality of subscriptions; and/or (c) the first paging channel results in minimizing power consumption in the wireless communication device.

### DRAWINGS

Various features, nature and advantages may become apparent from the detailed description set forth below when taken in conjunction with the drawings in which like reference characters identify correspondingly throughout.

FIG. 1 illustrates a first exemplary communication network environment in which a wireless communication device having multi-subscription capabilities may monitor a single paging channel for paging messages for two or more subscriptions with different core networks.

FIG. 2 (comprising FIGS. 2A and 2B) illustrates how a communication device may monitor just a single paging channel group associated with one subscription to receive paging messages for multiple subscriptions.

FIG. 3 illustrates a second exemplary communication network environment in which a communication device having multi-subscription capabilities may monitor a single paging channel for paging messages for two or more subscriptions with different core networks.

FIG. 4 (comprising FIGS. 4A and 4B) illustrates how a communication device may monitor just a single paging channel group associated with one subscription to receive paging messages for multiple subscriptions.

FIG. 5 is a block diagram illustrating a wireless communication device having dual SIM capabilities.

FIG. 6 is a block diagram illustrating an example of the wireless communication circuit of the wireless communication device.

FIG. 7 illustrates a method operational on a multi-subscription wireless communication device for consolidating paging channels for a plurality of subscriptions to a single paging channel.

FIG. 8 is a block diagram illustrating an network communication device adapted to consolidate paging channels for a wireless communication device.

FIG. 9 illustrates a method operational in an access network device for routing paging messages for a plurality of wireless subscriptions for a wireless communication device to a single paging channel.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may not be shown in detail in order not to obscure the embodiments.

### Overview

A first feature provides for a way to conserve power on a communication device having multiple radio access technologies, multiple-SIM capabilities, and/or multiple service capabilities. Such features permit the communication device to maintain multiple wireless subscriptions that use different paging channels to notify the communication device when a call is received. Instead of scanning different paging channels, power may be conserved by using a single paging channel from a serving access network for paging messages from different subscriptions. One way to accomplish this is to provide at least one of the serving access network or a core network information for a plurality of subscriptions for the communication device, where each of the plurality of wireless subscriptions is associated with a different paging channel. While separate core network registrations may be performed for each subscription with different core networks, the serving access network and/or a core network may select a single paging channel for all paging messages from the different core networks. The serving access network may route any paging messages on other paging channels to the selected paging channel. The communication device is informed of the selected paging channel so it monitors for paging messages for all subscriptions on that selected paging channel.

### First Exemplary Network Configuration—Consolidated Paging Channel

FIG. 1 illustrates a first exemplary communication network environment in which a wireless communication device having multi-subscription capabilities may monitor a single paging channel for paging messages for two or more subscriptions with different core networks. This example illustrates a first access network 102 having a first access point 104 through which wireless communication service is provided to a wireless communication device 106 according to one or wireless communication technologies. The first access network 102 may be communicatively coupled to a first core network A 108 and a second core network B 110. The first access network 102 provides wireless network access to the wireless communication device 106. Each of the first and second core networks A 108 and B 110 provide subscriber authentication, switching of calls, call/message routing, etc. Subscriber authentication is performed by the core networks A 108 and B 110 prior to the access network 102 forwarding paging messages to the communication device 106.

The wireless communication device 106 may be a dual SIM device, allowing it to maintain multiple concurrent service subscriptions. The communication device 106 may be adapted for dual SIM operation, where the communication device 106 may receive two subscriber identity/identification modules (SIM). For example, the communication device 106 may be Dual SIM Standby (DSS), Dual SIM Active (DSA), Dual talk, and/or Dual SIM Dual Active (DSDA). DSS allows two SIM cards in the communication device 106 to be on standby waiting for a call; when a call is established on one SIM card, the other is no longer active. DSA allows the communication device 106 having two transceiver chains to be connected to two core networks at the same time, and can switch between two calls without dropping either. Dual talk allows the communication device 106 to talk with two callers from different mobile service provides (i.e., on different core networks) at same time. DSDA allows the communication device 106 to receive a call in idle mode, once an active call on one SIM is established, a call indication may still be received on another SIM, allowing the user to switch between two calls without disconnecting either one of them. In one example, each subscription and/or SIM may include an International Mobile Subscriber Identity (IMSI) which may be used directly or indirectly to identify and/or authenticate the wireless communication device 106 with the access network and/or core networks A 108 and B 110.

In this exemplary configuration, the communication device 106 may register for service (e.g., using a first SIM) with the first core network A 108 and separately register for service (e.g., using a second SIM) with the second core network B 110. Each of these core networks may be associated with, or indicate, the use of different paging channels for each of the services/subscriptions of the communication device 106. According to one aspect, the access network 102 may receive paging messages for the communication device 106 which are intended to be transmitted on different channels. However, the access network 102 may route all paging messages to a single channel so that the communication device 106 need only monitor a single channel for paging messages for two or more services/subscriptions. In various examples, communication device 106 may be a mobile phone, a wireless phone, a computing device with voice call capabilities, etc.

FIG. 2 (comprising FIGS. 2A and 2B) illustrates how a communication device may monitor just a single paging channel group associated with one subscription to receive paging messages for multiple subscriptions. This example refers to the exemplary network configuration of FIG. 1. As previously noted, the communication device 106 may be a dual SIM device so it may be provisioned with a plurality of subscriptions Subs-A 202 and Subs-B 204. Each subscription may correspond to a different SIM. Note that, in other implementations, the communication device 106 may include more than two SIMs and/or more than two subscriptions. In one example, each subscription may correspond to a communication service facilitated by a service provider operating a core network that authenticates each communication device and/or subscription prior to providing communication service.

In this example, the communication device 106 may, optionally, perform a first core network registration 206, via the access network 102, with the first core network 108 for service using the first subscription Subs-A 202. Optionally, the communication device 106 may also perform a second core network registration 210, via the access network 102, with the second core network 110 for service using the second subscription Subs-B 204. The access network 102 and/or the communication device 106 may be notified of successful authentications 208 and/or 212 of the subscriptions Subs-A 202 and Subs-B 204, respectively. As part of this process, the access network 102 obtain (e.g., receive or generate) a first paging channel 214 for the first subscription Subs-A 202 and/or a second paging channel 216 for the second subscription Subs-B 204.

According to one exemplary implementation, the communication device 106 may send an access network registration message 218a to the access network 102 in which it sends all of its subscriptions (e.g., Subs-A, Subs-B, etc.) to the serving access network (Access Network A 102). This may occur, for example, where the access network 102 is a wifi network or a Global System for Mobile Communication (GSM) Enhanced Data rates for GSM Evolution (EDGE) Radio Access Network (GERAN). This approach may be used, for example, where an access point for the access network may have the capability to assist in authenticating a subscription for the communication device 106, selecting a paging channel for one of the subscriptions as a master paging channel, and/or routing all paging messages for the subscriptions to the master paging channel. Consequently, the serving Access Network A 102 (e.g., RAN/BSC, etc.) is provided with knowledge of which subscription identities belong to the communication device 106.

According to another exemplary implementation, the communication device 106 may send a core network registration message 218b to the core network 108 in which it sends all of its subscriptions (e.g., Subs-A, Subs-B, etc.) to the core network (Core Network A 108). Consequently, the serving Access Network A 102 (e.g., RAN/BSC, etc.) may be provided, by the Core Network A 108, with knowledge of which subscription identities belong to the communication device 106. In one example, the core network registration message 218b may be a modified core network registration message capable of conveying the plurality of subscriptions for the communication device 106 to the core network A 108.

In either of the two registration approaches 218a and/or 218b, either the access network 102 and/or the core network A 108, alone or operating together, may select the master subscription and/or paging channel.

Note that in some implementations, the first and/or second core network registrations 206 and/or 210 may include the plurality of subscriptions (Subs-A, Subs-B, . . . ) so that the separate registration messages 218a and/or 218b are not needed.

This way the serving Access Network A 102 may select, designate, or obtain an indication of, one subscription (e.g., Subs-A) as the master subscription 220 and notifies 222 the communication device 106 of the corresponding selected Paging Channel-A. The Access Network A 102 may then route all paging messages for all the subscriptions (Subs-A, Subs-B, etc.) using the selected Paging Channel-A) associated with the master subscription Subs-A. The communication device 106 only needs to monitor 224 the selected Paging Channel A. For instance, a paging message 226 from the first core network A 108 is forwarded 228 on the selected Paging Channel-A. In another instance, a paging message 230 from the second core network B 110 is rerouted 232 and forwarded 234 on the selected Paging Channel-A. In this manner, the communication device 202 can receive 236 paging messages for all subscriptions Subs-A and Subs-B on the selected Paging Channel-A and avoids monitoring multiple paging channels (e.g., Paging Channel(s) B, etc.).

Note that in some implementations, the communication device 106 may send the Registration message(s) 218a and/or 218b after the first core network registration 206 has been successful, and prior to any other core network registration. In fact, the second core network registration 210 may not be performed at all. Thus, when the registration message 218a and/or 218b is sent, only subscription Subs-A 202 may be authenticated, thus allowing the access network 102 and/or the first core network A 108 to select the active first subscription Subs-A 202 and use its paging channel for paging messages associated with all other subscriptions. In other examples, the second core network registration 210 may be performed after the access network registration 218.

Furthermore, in one implementation, if one of the subscriptions is in connected mode, then the Access Network A 102 is aware of this and can send the paging messages for the idle subscriptions using the radio resources allocated to the connected mode subscription. This way the idle mode subscriptions do not miss the paging messages.

### Second Exemplary Network Configuration—Consolidated Paging Channel

FIG. 3 illustrates a second exemplary communication network environment in which a communication device having multi-subscription capabilities may monitor a single paging channel for paging messages for two or more subscriptions with different core networks. This example illustrates a first access network 302 having a first access point 304 through which wireless communication service is provided to a mobile communication device 306 according to one or wireless communication technologies. The first access network A 302 may be communicatively coupled to a first core network A 308. Additionally, a second access network C 303 may include a second access point 305 through which wireless communication service is provided to the mobile communication device 306 according to one or wireless communication technologies. The second access network C 303 may be communicatively coupled to a second core network C 310. Each of the first and second core networks A 308 and C 310 provide subscriber authentication, switching of calls, call/message routing, etc. Subscriber authentication may be performed by the core networks A 308 and C 310 prior to the access network 302 forwarding paging messages to the communication device 306.

The mobile communication device 306 may be a dual SIM device, allowing it to maintain multiple concurrent service subscriptions. The communication device 306 may be adapted for dual SIM operation, where the communication device 306 may receive two subscriber identity/identification modules (SIM). In one example, each subscription and/or SIM may include an International Mobile Subscriber Identity (IMSI) which may be used directly or indirectly to identify and/or authenticate the wireless communication device 106 with the access network and/or core networks A 108 and B 110.

In this exemplary configuration, the communication device 306 may register for service (e.g., using a first SIM) with the first core network A 308 via the first access network A 302. Separately, the communication device 306 may register for service (e.g., using a second SIM) with the second core network C 310 via the second access network 303. Each of these core networks A 308 and C 310 may be associated with, or indicate, the use of different paging channels for each of the services/subscriptions of the communication device 306. According to one aspect, the first access network 302 may receive paging messages for the communication device 306 which are intended to be transmitted on different channels. However, the first access network 302 may route all paging messages to a single channel so that the communication device 306 need only monitor a single channel for paging messages for two or more services/subscriptions. The first and second access networks A 302 and C 303 may be in communication with each other, allowing the second access network C 303 to reroute paging messages for the communication device 306 to the first access network A 302 rather than transmitting them over the a second access point 305.

FIG. 4 (comprising FIGS. 4A and 4B) illustrates how a communication device may monitor just a single paging channel group associated with one subscription to receive paging messages for multiple subscriptions. This example refers to the exemplary network configuration of FIG. 3. As previously noted, the communication device 306 may be a dual SIM device so it may be provisioned with a plurality of subscriptions Subs-A 302 and Subs-C 303. Each subscription may correspond to a different SIM. Note that, in other implementations, the communication device 306 may include more than two SIMs and/or more than two subscriptions. In one example, each subscription may correspond to a communication service facilitated by a service provider operating a core network that authenticates each communication device and/or subscription prior to providing communication service.

In this example, the communication device 306 may, optionally, perform a first registration 406, via the first access network A 302, with the first core network 308 for service using the first subscription Subs-A 402. Optionally, the communication device 306 may also perform a second registration 410, via the second access network C 303, with the second core network 310 for service using the second subscription Subs-C 304. The first access network 302 and/or the communication device 106 may be notified of successful authentication 408 of the subscription Subs-A 402. Similarly, the second access network 303 and/or the communication device 106 may be notified of successful authentication 412 of the subscription Subs-C 404. As part of this process, the first access network 302 may obtain (e.g., receive or generate) a first paging channel 414 for the first subscription Subs-A 402. Similarly, the second access network 303 may obtain (e.g., receive or generate) a second paging channel 416 for the second subscription Subs-C 404.

According to one exemplary implementation, the communication device 306 may send an access network registration message 418a to the first access network 302 in which it sends two or more of its subscriptions (e.g., Subs-A, Subs-C, etc.) to the first access network (Access Network A 302). This may occur, for example, where the access network 302 is a wifi network or a Global System for Mobile Communication (GSM) Enhanced Data rates for GSM Evolution (EDGE) Radio Access Network (GERAN). This approach may be used, for example, where an access point for the access network may have the capability to assist in authenticating a subscription for the communication device 306, selecting a paging channel for one of the subscriptions as a master paging channel, and/or routing all paging messages for the subscriptions to the master paging channel. Consequently, the first Access Network A 302 (e.g., RAN/BSC, etc.) is provided with knowledge of which subscription identities belong to the communication device 106.

According to another exemplary implementation, a core network registration message 418b is instead sent (with two or more subscriptions Subs-A, Subs-B, . . . ) from the communication device 306 to the Core Network A 308 with all or a plurality of its subscriptions (Subs-A, Subs-B, etc.) on the communication device 306. Consequently, the serving Access Network A 302 (e.g., RAN/BSC, etc.) may be provided, by the Core Network A 308, with knowledge of which subscription identities belong to the communication device 306.

In either of the two registration approaches 418a and/or 418b, either the access network 302 and/or the core network A 308, alone or operating together, may select the master subscription and/or paging channel.

Note that in some implementations, the first and/or second core network registrations 406 and/or 410 may include the plurality of subscriptions (Subs-A, Subs-B, . . . ) so that the separate registration messages 418a and/or 418b are not needed.

In this manner, the first Access Network A 302 may select, designate, or obtain an indication of, one subscription (e.g., Subs-A) as the master subscription 420 and notifies 422 the communication device 306 of the corresponding selected Paging Channel-A. The first Access Network A 302 may then route all paging messages for all the subscriptions (Subs-A, Subs-C, etc.) using the selected Paging Channel-A associated with the master subscription Subs-A.

Note that in some implementations, the communication device 306 may send the Registration message(s) 418a and/or 418b after the first core network registration 406 has been successful, and prior to any other core network registration. In fact, the second core network registration 410 may not be performed at all.

If subscription Subs-A 402 is already authenticated, the first access network A 302 and/or first core network may select the active first subscription Subs-A 402 and use its paging channel (i.e., Paging Channel-A) for paging messages associated with all other subscriptions.

The first Access Network A 302 and/or first core network A 308 may also send a paging rerouting message 424 to the second Access Network C 303 and/or the second core network C 310, thereby allowing the second Access Network C 303 to forward paging messages 428 for the second subscription Subs-C 404 to the first Access Network A 302.

The communication device 306 only needs to monitor 426 the selected Paging Channel A. For instance, a paging message 430 from the first core network A 308 is forwarded by the first Access Network A 302 on the selected Paging Channel-A. In another instance, a paging message 432 from the second core network C 310 is rerouted 434 and forwarded 436 by the second Access Network C 303 to the first Access Network A 302. The first Access Network A 302 may forward 438 any such paging messages forwarded by the second Access Network C 303 to the communication device 306. In this manner, the communication device 306 can receive 440 paging messages for all subscriptions Subs-A and Subs-C on the selected Paging Channel-A and avoids monitoring multiple paging channels (e.g., Paging Channel(s) C, etc.).

### Exemplary Dual SIM Communication Device

FIG. 5 is a block diagram illustrating a wireless communication device 502 having dual SIM capabilities. The wireless communication device 502 may include a processing circuit 504 coupled to a wireless communication circuit 506, a first subscriber identity module (SIM) A 508, a second subscriber identity module (SIM) B 510, an audio input device 514 (e.g., one or more microphones), an audio output device 516 (e.g., one or more audio speakers), a keypad input device 518, and/or a display output device 520. The wireless communication circuit 506 may facilitate wireless communications over two or more distinct wireless access networks 512 as specified by the first SIM A 508 and/or the second SIM B 510.

The processing circuit 504 may include a dual SIM, dual active module or circuit 522 that allows the communication device 502 to use both SIMs concurrently. This may allow the wireless communication device 502 to make and/or receive calls via distinct wireless subscriber accounts, phone numbers, and/or wireless subscriber/communication networks (e.g., utilizing distinct wireless technologies and/or protocols). The first SIM A 508 and second SIM B 510 may be integrated with the communication device 502 or they may be separate modules that are coupled to an interface or slot in the communication device 502. In one example, the first SIM A 508 may be associated with a first subscription and the second SIM B 510 may be associated with a second subscription.

FIG. 6 is a block diagram illustrating an example of the wireless communication circuit 506 of the wireless communication device 502. In this example, at least two transceiver chains may be implemented that can be concurrently active. For instance, the wireless communication circuit 506 may include a first and a second radio frequency (RF) processors 604 and 606 coupled to a first radio frequency front end (interface) 610 and second radio frequency front end (interface) 612, respectively. Both the first and second radio frequency processors 604 and 606 may be coupled to a modem processor 608. A first transceiver chain may include the first radio RF processor 604 and the first RF front end 610. A second transceiver chain may include the second radio RF processor 606 and the second RF front end 612. Consequently, the wireless communication device 502 may be able to communicate over one or more access networks and/or core networks via the first frequency radio front 510 and, concurrently, via the second frequency radio front end 512.

Referring again to FIG. 5, the processing circuit 502 may include or implement a dual SIM dual active module/circuit 522 that permits the communication device 502 to establish and/or maintain communication sessions/calls associated with subscriptions for one or both SIMs A and B 508 and 510.

The processing circuit 504 may also include or implement a core network registration module/circuit 524 adapted to perform registration (e.g., seeking authentication of a subscription) for one or more subscriptions associated with the first SIM A 508 and/or the second SIM B 510.

The processing circuit 504 may also include or implement an access network registration module/circuit 526 adapted to provide the access network 512 and/or one or more core networks information for two or more subscriptions for the wireless communication device 502. This may cause the access network 512 and/or one or more core networks to select one of the subscriptions and its corresponding paging channel for all paging messages associated with all subscriptions for the wireless communication device 502.

The processing circuit 504 may also include a paging channel monitoring module/circuit 528 that is adapted to monitor a single paging channel for paging messages for two or more different subscriptions. That is, even though the core networks associated with such subscriptions may be utilizing or may have assigned or expect a different paging channel for each subscription, the wireless communication device 502 may have requested the access network consolidate all paging messages for all of its subscriptions (or a subset plurality of subscriptions) to be sent on a single paging channel that is defined by the wireless communication device 502 and/or the access network 512.

In some implementations, the processing circuit 504 may also include or implement a paging channel selector module/circuit 530 that is adapted to select a paging channel from among a plurality of paging channels and convey a preference for using this selected paging channel to the serving access network and/or a core network. For instance, the paging channel selector module/circuit may identify a preferred paging channel from at least one of: (a) a paging channel having the lowest noise-to-energy ratio from among the plurality of paging channels; (b) a paging channel having the highest signal energy from among the plurality of paging channels; and/or (c) a paging channel associated with a subscription that is in a connected mode when registration with the serving access network is initiated.

FIG. 7 illustrates a method operational on a multi-subscription wireless communication device for consolidating paging channels for a plurality of subscriptions to a single paging channel. The wireless communication device may include two or more SIMs (or equivalent) associated with two or more different subscriptions for wireless service. Such subscriptions are unique to the wireless communication device and/or to a user of the wireless communication device. Optionally, the wireless communication device may initially register with a first core network for authentication of a first subscription 702. Subsequently, the wireless communication device may register with at least one of a serving access network or the first core network while providing information for a plurality of subscriptions, including the first subscription, where each of the plurality of subscriptions is associated with a different paging channel 706. Such registration may be a message reporting a plurality of distinct subscriptions for the wireless communication device. The plurality of subscriptions may facilitate wireless communication services for the wireless communication device over two or more different core networks. In one example, each of the plurality of subscriptions is associated with a different core network.

In response to sending all or a plurality of its subscriptions to the serving access network and/or first core network, the wireless communication device may receive an indication that a first paging channel associated with one of the subscriptions has been selected for all paging messages for the plurality of subscriptions 708. In one example, the first paging channel may correspond to a subscription from the plurality of subscriptions that is in a connected mode (e.g., a subscription for which the wireless communication device has an active communication session) and/or a subscription for which registration with a core network has occurred. The indication, from the serving access network and/or first core network, may identify an existing subscription, from the plurality of subscriptions, associated with the first paging channel.

Consequently, the wireless communication device may monitor the first paging channel for paging messages for the plurality of subscriptions 710. That is, even though some of the other subscriptions (in the plurality of subscriptions) may have been associated with other paging channels (distinct from the first paging channel), the wireless communication device may forego monitoring said other paging channels (e.g., to conserve power) and just monitors the first paging channel for paging messages associated with both the plurality of subscriptions. The wireless communication device may subsequently receive paging messages for at least two of the plurality of subscriptions over the first paging channel 712.

The concatenation and/or routing of the different paging channels for the plurality of subscriptions to the first paging channel may be unknown to the first core network and/or any other core network associated with any of the plurality of subscriptions. That is, this power management technique may be implemented between the wireless communication device and one or more access networks, without notification or approval of any of the core networks.

In one example, this method permits the wireless communication device to indicate which subscriptions it wishes to consolidate for purposes of reducing the number of paging channels that need to be monitored for paging messages. For example, for a multi-subscription wireless communication device (e.g., a device having multiple SIMs), it can decide to consolidate paging channels for some subscriptions, but not all. Alternatively, the multi-subscription wireless communication device may define different groups of subscriptions and may consolidate the paging channels for the subscriptions in each group separately.

In some instances, the wireless communication device may ascertain a preferred paging channel, from among a plurality of paging channels associated with the plurality of subscriptions. The wireless communication device may then provide an indication of the preferred paging channel to the serving access network. In various examples, the preferred paging channel may be ascertained from at least one of: (a) a paging channel having the lowest noise-to-energy ratio from among the plurality of paging channels; (b) a paging channel having the highest signal energy from among the plurality of paging channels; and (c) a paging channel associated with a subscription that is in a connected mode when registration with the serving access network is initiated.

According to yet another aspect, the wireless communication device may define (e.g., within the registration message to the access network) which of its subscriptions it prefers, thereby indicating to the serving access network that the paging channel for such preferred subscription should be used to consolidate all pages for different subscriptions for the wireless communication device.

This method may also allow the wireless communication device to decide when to seek consolidation of its paging channel(s). For example, in some instances, the wireless communication device may send the registration message to the serving access network when its power supply has fallen below a threshold level and wishes to conserve power. In yet other instances, the wireless communication device may send the registration message to the serving network to consolidate its paging channel(s) to the paging channel for which it has strongest signal reception.

In some instances, the wireless communication device may be in a connected mode for the first subscription but in idle mode for a second subscription from the plurality of subscriptions. Consequently, the first paging channel (which is previously associated with the first subscription) may be selected for transmitting all paging messages for the first and second subscription to the wireless communication device. In other examples, the first paging channel is not associated with the first subscription but is selected nonetheless because: (a) it may be more power efficient options, and/or (b) the wireless communication device has indicated a preference for using a subscription associated with that channel, etc.

Generally, each subscription in the plurality of subscriptions is to be registered separately with a core network that is different from other core networks for other subscriptions in the plurality of subscriptions. In one example, the wireless communication device may register with a second core network for authentication of the second subscription 704. This registration with the second core network may occur either before or after the wireless communication device performs the registration 706 with the serving access network. Such registration with the second core network may result in a second paging channel being associated with the second subscription. In one example, even though a second paging channel has been associated with the second subscription, the serving access network still uses the first paging channel for the paging messages for the second subscription. However, the serving access network may also decide to change from using the first paging channel to using the second paging channel (for paging messages for all subscriptions of the wireless communication device) if the second subscription is in a connected mode (e.g., an active communication session is established on the second subscription), and provides a notification of this change to the wireless communication device.

### Exemplary Network Communication Device

FIG. 8 is a block diagram illustrating network communication device 802 adapted to consolidate paging channels for a wireless communication device. In various implementations, the network communication device 802 may be an access network device (e.g., a paging device) or a core network device.

The network communication device 802 may include a processing circuit 804 coupled to a wireless communication circuit 806, a network communication circuit 808, and/or a memory/storage device 814. The wireless communication circuit 806 may facilitate voice and/or data communication sessions to and/or from one or more wireless communication devices 810.

Where the network communication device 802 is an access network device, the network communication circuit 808 may facilitate voice and/or data communications to and/or from one or more core networks 812. The memory/storage device 814 may allow the processing circuit 804 to store paging channels 816 for each subscription (e.g., for the wireless communication devices it currently serves). The memory/storage device 814 may also store paging channel mappings 818 for the wireless communication devices it currently serves. Such mappings may indicate a mapping of a plurality of paging channels (e.g., associated with different subscriptions for a particular wireless communication device) into a single paging channel associated with one subscription for the wireless communication device.

The processing circuit 804 may include or implement a communication device subscription registration module/circuit 822 which is adapted to receive a registration message from a wireless communication device (e.g., via the wireless communication interface) that includes information for two or more subscriptions associated with the wireless communication device. A paging channel consolidation module/circuit 824, implemented by the processing circuit 804, may be adapted to select a subscription from among the two or more subscriptions in the registration message to be used for all paging messages associated with a plurality of subscriptions for one wireless communication device.

Where the network communication device 802 is a core network device, it may authenticate at least one subscription and/or provide the selected subscription to the access network device. Such selection of a particular subscription (e.g., master subscription) may be based on a preference order pre-established for the wireless communication device, based on information received from other core networks, and/or from a preference conveyed by the wireless communication device. For instance, the wireless communication device may determine a subscription based on signal strength, roaming charges, etc. This selection of a particular subscription (e.g., master subscription) may be conveyed to the access network device.

Alternatively, where the network communication device 802 is an access network device, it may select subscription (e.g., based on connected status, communication device preference, etc.) and/or select a corresponding paging channel as a master paging channel for all other subscriptions. Such selection of a particular subscription (e.g., master subscription) may be based on the connected mode of each subscription (e.g., subscriptions that have been authenticated and are in a connected or active mode are preferred over subscriptions that are in idle mode), based on a preferred subscription received from one or more core networks, and/or from a preference conveyed by the wireless communication device.

Where the network communication device 802 is an access network device, a paging message rerouting module/circuit 826 may be adapted to reroute all paging messages for a wireless communication device to a single paging channel for a subscription of associated with the wireless communication device. For instance, even different paging channels have been previously assigned for each of a first and second subscriptions for a wireless communication device, a subsequent mapping may result in all paging messages for the first and second subscriptions to be rerouted to a first paging channel (e.g., previously assigned to the first subscription).

FIG. 9 illustrates a method operational in an access network device for routing paging messages for a plurality of wireless subscriptions for a wireless communication device to a single paging channel. The access network device may receive a plurality of subscriptions from a wireless communication device as part of an access network registration for the wireless communication device, where each of the plurality of the subscriptions are associated with a different paging channel 902. The access network device may then select/obtain a first paging channel associated with a first wireless subscription from the plurality of subscriptions 904. In various examples, the first paging channel may be selected after ascertaining that: (a) the first paging channel is in a connected mode with a first core network; (b) the first paging channel has the lowest noise-to-energy ratio from among a plurality of paging channels associated with the plurality of subscriptions; and/or (c) the first paging channel results in minimizing power consumption in the wireless communication device.

In some implementations, the access network device may receive a selection of the first wireless subscription from a core network and uses the corresponding paging channel as the first paging channel. Alternatively, the access network device may select the first wireless subscription, from among the plurality of subscriptions, and uses the corresponding paging channel as the first paging channel.

The access network entity may send a message to the wireless communication device indicating that the first paging channel has been selected for sending all paging messages for the plurality of subscriptions 906. In one example, such message may indicate the subscriber account that has been selected and which corresponds to the first paging channel. In another example, the actual paging channel may be sent in the message. Paging messages for the plurality of wireless subscriptions for the wireless communication device are then routed to the first paging channel 908. For instance, the access network device may send paging messages for the plurality of subscriptions to the wireless communication device via the first paging channel 910.

In some instances, a first access network may inform a second access network that paging messages for one of the subscriptions being served by the second access network should be routed to the first access network. This may involve the wireless communication device sending the access network registration message to both the first and second access networks.

One or more of the components, steps, features and/or functions illustrated in the Figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the Figures may be configured to perform one or more of the methods, features, or steps described in the Figures. The novel algorithms described herein may also be efficiently implemented in software and/or embedded in hardware.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational on a wireless communication device, comprising:
registering with at least one of a serving access network or a first core network while providing information for a plurality of subscriptions, including the first subscription, of the wireless communication device, where each of the plurality of subscriptions is associated with a different paging channel;
receiving an indication that a first paging channel associated with one of the plurality of subscriptions has been selected for all paging messages for the plurality of subscriptions; and
monitoring the first paging channel for paging messages for the plurality of subscriptions.

2. The method of claim 1, further comprising:
receiving paging messages from at least two of the plurality of subscriptions over the first paging channel.

3. The method of claim 1, wherein the plurality of subscriptions facilitates wireless communication services for the wireless communication device over two or more different core networks.

4. The method of claim 1, wherein each of the plurality of subscriptions is associated with a different core network.

5. The method of claim 1, wherein the wireless communication device provides the information for the plurality of subscriptions to the serving access network in order to reduce the number paging channels it monitors for paging messages.

6. The method of claim 1, wherein routing of the different paging channels for the plurality of subscriptions to the first paging channel is unknown to the first core network.

7. The method of claim 1, wherein the first paging channel was previously associated with the first subscription.

8. The method of claim 1, wherein the first paging channel is associated with a subscription different from the first subscription.

9. The method of claim 1, wherein each subscription in the plurality of subscriptions is to be registered separately with a core network that is different from other core networks for other subscriptions in the plurality of subscriptions.

10. The method of claim 1, wherein the first paging channel corresponds to a subscription from the plurality of subscriptions that is in a connected mode.

11. The method of claim 1, wherein the indication identifies an existing subscription, from the plurality of subscriptions, associated with the first paging channel.

12. The method of claim 1, further comprising:
ascertaining a preferred paging channel, from among a plurality of paging channels associated with the plurality of subscriptions.

13. The method of claim 12, further comprising:
providing an indication of the preferred paging channel to the serving access network.

14. The method of claim 12, wherein the preferred paging channel is ascertained from at least one of:
a paging channel having the lowest noise-to-energy ratio from among the plurality of paging channels;
a paging channel having the highest signal energy from among the plurality of paging channels; and
a paging channel associated with a subscription that is in a connected mode when registration with the serving access network is initiated.

15. A wireless communication device, comprising:
a wireless communication circuit adapted for communications with a serving access network;
a processing circuit coupled to the wireless communication circuit, the processing circuit configured to
register with at least one of the serving access network or a first core network while providing information for a plurality of subscriptions, including the first subscription, of the wireless communication device, where each of the plurality of subscriptions is associated with a different paging channel;
receive an indication that a first paging channel associated with one of the plurality of subscriptions has been selected for all paging messages for the plurality of subscriptions; and
monitor the first paging channel for paging messages for the plurality of subscriptions.

16. The wireless communication device of claim 15, wherein the processing circuit is further configured to:
receive paging messages from at least two of the plurality of subscriptions over the first paging channel.

17. The wireless communication device of claim 15, wherein the plurality of subscriptions facilitates wireless communication services for the wireless communication device over two or more different core networks.

18. The wireless communication device of claim 15, wherein each of the plurality of subscriptions is associated with a different core network.

19. The wireless communication device of claim 15, wherein the first paging channel was previously associated with the first subscription.

20. The wireless communication device of claim 15, wherein the first paging channel is associated with a subscription different from the first subscription.

21. The wireless communication device of claim 15, wherein each subscription in the plurality of subscriptions is to be registered separately with a core network that is different from other core networks for other subscriptions in the plurality of subscriptions.

22. The wireless communication device of claim 15, wherein the first paging channel corresponds to a subscription from the plurality of subscriptions that is in a connected mode.

23. The wireless communication device of claim 15, wherein the indication identifies an existing subscription, from the plurality of subscriptions, associated with the first paging channel.

24. The wireless communication device of claim 15, wherein the processing circuit is further configured to:
ascertain a preferred paging channel, from among a plurality of paging channels associated with the plurality of subscriptions.

25. The wireless communication device of claim 24, wherein the processing circuit is further configured to:
provide an indication of the preferred paging channel to the serving access network.

26. A wireless communication device, comprising:
means for registering with at least one of a serving access network or a first core network while providing information for a plurality of subscriptions, including the first subscription, of the wireless communication device, where each of the plurality of subscriptions is associated with a different paging channel;
means for receiving an indication that a first paging channel associated with one of the plurality of subscriptions has been selected for all paging messages for the plurality of subscriptions; and
means for monitoring the first paging channel for paging messages for the plurality of subscriptions.

27. The wireless communication device of claim 26, further comprising:
means for receiving paging messages from at least two of the plurality of subscriptions over the first paging channel.

28. The wireless communication device of claim 26, further comprising:
means for ascertaining a preferred paging channel, from among a plurality of paging channels associated with the plurality of subscriptions; and
means for providing an indication of the preferred paging channel to the serving access network.

29. A processor-readable storage medium having one or more instructions operational in a wireless communication device, which when executed by one or more processors causes the one or more processors to:
register with at least one of a serving access network or a first core network while providing information for a plurality of subscriptions, including the first subscription, of the wireless communication device, where each of the plurality of subscriptions is associated with a different paging channel;
receive an indication that a first paging channel associated with one of the plurality of subscriptions has been selected for all paging messages for the plurality of subscriptions; and
monitor the first paging channel for paging messages for the plurality of subscriptions.

30. The processor-readable storage medium of claim 29, further comprising one or more instructions which when executed by the one or more processors causes the one or more processors to:
receive paging messages from at least two of the plurality of subscriptions over the first paging channel.

31. A method operational on an access network device, comprising:
receiving a plurality of subscriptions from a wireless communication device, where each of the plurality of subscriptions is associated with a different paging channel;
obtaining a first paging channel associated with a first subscription from the plurality of subscriptions; and
routing paging messages for the wireless communication device from the plurality of subscriptions via the first paging channel.

32. The method of claim 31, further comprising:
sending paging messages for the plurality of subscriptions to the wireless communication device via the first paging channel.

33. The method of claim 31, further comprising:
sending a message to the wireless communication device indicating that the first paging channel has been selected for sending all paging messages for the plurality of subscriptions.

34. The method of claim 31, further comprising:
informing a second access network that paging messages for at least one of the plurality subscriptions should be routed to the first access network.

35. The method of claim 31, wherein each of the plurality of subscriptions is associated with a different core network.

36. The method of claim 31, wherein the plurality of subscriptions facilitates wireless communication services for the wireless communication device over two or more different core networks.

37. The method of claim 31, wherein routing of the different paging channels for the plurality of subscriptions to the first paging channel is unknown to a plurality of core networks associated with the plurality of subscriptions.

38. The method of claim 31, wherein the first paging channel was previously associated with the first subscription.

39. The method of claim 31, wherein the first paging channel is associated with a subscription different from the first subscription.

40. The method of claim 31, wherein each subscription in the plurality of subscriptions is to be registered separately with a core network that is different from other core networks for other subscriptions in the plurality of subscriptions.

41. The method of claim 31, wherein the wireless communication device indicates a preference for using the first paging channel associated with the first subscription to receive paging messages for the plurality of subscriptions.

42. The method of claim 31, wherein the first paging channel is selected after ascertaining that:
the first paging channel is in a connected mode with a first core network;
the first paging channel has the lowest noise-to-energy ratio from among a plurality of paging channels associated with the plurality of subscriptions; or
the first paging channel results in minimizing power consumption in the wireless communication device.

43. An access network device, comprising:
a wireless communication circuit adapted for communications with a serving access network;
a processing circuit coupled to the wireless communication circuit, the processing circuit configured to
receive a plurality of subscriptions from a wireless communication device, where each of the plurality of subscriptions is associated with a different paging channel;
obtain a first paging channel associated with a first subscription from the plurality of subscriptions; and
route paging messages for the wireless communication device from the plurality of subscriptions via the first paging channel.

44. The access network device of claim 43, wherein the processing circuit is further configured to
send paging messages for the plurality of subscriptions to the wireless communication device via the first paging channel.

45. The access network device of claim 43, wherein the processing circuit is further configured to:
send a message to the wireless communication device indicating that the first paging channel has been selected for sending all paging messages for the plurality of subscriptions.

46. The access network device of claim 43, wherein the processing circuit is further configured to:
inform a second access network that paging messages for at least one of the plurality subscriptions should be routed to the first access network.

47. An access network device, comprising:
means for receiving a plurality of subscriptions from a wireless communication device, where each of the plurality of subscriptions is associated with a different paging channel;
means for obtaining a first paging channel associated with a first subscription from the plurality of subscriptions; and
means for routing paging messages for the wireless communication device from the plurality of subscriptions via the first paging channel.

48. The access network device of claim 47, further comprising:
means for sending paging messages for the plurality of subscriptions to the wireless communication device via the first paging channel.

49. The access network device of claim 47, further comprising:
means for sending a message to the wireless communication device indicating that the first paging channel has been selected for sending all paging messages for the plurality of subscriptions.

50. The access network device of claim 47, further comprising:
means for informing a second access network that paging messages for at least one of the plurality subscriptions should be routed to the first access network.

51. A processor-readable storage medium having one or more instructions operational in an access network device, which when executed by one or more processors causes the one or more processors to:
receive a plurality of subscriptions from a wireless communication device, where each of the plurality of subscriptions is associated with a different paging channel;
obtain a first paging channel associated with a first subscription from the plurality of subscriptions; and
route paging messages for the wireless communication device from the plurality of subscriptions via the first paging channel.

52. The processor-readable storage medium of claim 51, further comprising one or more instructions which when executed by the one or more processors causes the one or more processors to:
send paging messages for the plurality of subscriptions to the wireless communication device via the first paging channel.

53. The processor-readable storage medium of claim 51, further comprising one or more instructions which when executed by the one or more processors causes the one or more processors to:
send a message to the wireless communication device indicating that the first paging channel has been selected for sending all paging messages for the plurality of subscriptions.
